(19) United States
(12) Patent Application Publication
(10) Pub. No.: US 2026/0141059 A1
(43) Pub. Date: May 21, 2026

(54) System and method for detecting and managing a data breach in a computing network

(71) Applicant: Bank of America Corporation, Charlotte, NC (US)

(72) Inventors: Jemlin Lucas, Coppell, TX (US); Suryanarayana Adivi, Hyderabad (IN); Pushkar Taneja, Hyderabad (IN)

(21) Appl. No.: 18/953,617

(22) Filed: Nov. 20, 2024

(51) Int. Cl. G06F 21/55; G06F 21/54

(52) U.S. Cl. CPC G06F 21/554; G06F 21/54; G06F 21/552

(57) ABSTRACT

In response to detecting that a first data interaction has been performed in relation to a first user, it is determined, based on one or more historical interaction logs associated with previous data interactions performed in relation to the first user, that the first data interaction does not at least partially match with the previous data interactions. In response, it is determined that a potential data breach has occurred. A trained AI model is used to verify the potential data breach to confirm whether the data breach has actually occurred. Upon successfully confirming the potential data breach, one or more remediation methods are determined and implemented to avoid damage to impacted areas because of the data breach.

### TECHNICAL FIELD

The present disclosure relates generally to network security, and more specifically to a system and method for detecting and managing a data breach in a computing network.

### BACKGROUND

In conventional systems a cyber-attack on a computing system that results in a data breach is detected after damage to computing systems has occurred because of the data breach. In one example, a data breach may include unauthorized installing of malicious software code at a computing device (e.g., data server) that performs malicious activities to disrupt an operation of the computing device by creating unwanted files to slow down the speed and performance of the computing device, corrupting files, or crashing some software or executable applications so that they cannot be executed. In another example, a data breach may include access to sensitive data, such as personal information without authorization. In another example, a data breach may exfiltrate data by transmitting confidential data to unauthorized devices. Conventional systems lack the capability to detect data breaches and apply security measures that avoid or prevent the data breach from causing damage to computing systems.

### SUMMARY

The system and method implemented by the system as disclosed in the present disclosure provide technical solutions to the technical problems discussed above by proactively detecting data breaches and implementing remediation methods to avoid damage (e.g., data theft, compromised computing performance, device failure etc.) to computing systems.

Often computing systems that store, process, or handle sensitive data in some manner are prone to cyber-attacks or data breaches in which a hacker gains unauthorized access to the computing systems and data stored on the computing systems. The term “cyber-attack” is often used interchangeably with the term “data breach” and refers to any security incident in which unauthorized parties access computing systems and sensitive or confidential information, including but not limited to, Non-Public Information (NPI), Personal Identification Information (PII), Production Information, or any other data that is designated as sensitive data. In one example, a data breach may include unauthorized installing of malicious software code (e.g., malware) at a computing device (e.g., data server), wherein the malicious software is configured to perform malicious activities to disrupt an operation of the computing device, for example, by creating unwanted files to slow down the speed and performance of the computing device, corrupting files, or crashing some software or executable applications so that they cannot be executed. A malware can infect many types of devices, including cell phones, computers, tables, and smart televisions. It usually spreads by duplicating itself and hiding in a device’s data files. A malware attack often results in compromised computing performance by causing slow processor performance, browser redirects, frequent infection warnings, frequent pop-up ads, problems starting up and shutting down a computing node, sudden loss of memory disk space, repeated system crashes and freezes, disabled security features, changes in file name and sizes, programs opening and closing themselves, or a combination thereof. In some cases, a malware locks up networks and computing nodes making them unusable. In another example, a data breach may include access to sensitive data, such as personal information without authorization. In another example, a data breach may exfiltrate data by transmitting confidential data to unauthorized devices. In some cases, the stolen data may be used to perform other unauthorized data interactions within the computing infrastructure and to gain access to other computing nodes and cause damage (e.g., data theft, compromised computing performance, device failure etc.) to those other computing nodes.

Conventional systems generally implement a reactive approach to detecting and remediating data breaches. For example, conventional systems lack the capability to detect data breaches efficiently and accurately. Further, conventional systems cannot apply security measures that avoid or prevent the data breach from causing damage (e.g., data theft, compromised computing performance, device failure etc.) to computing systems. Usually, by the time a data breach is detected, the damage to the breached computing systems has already taken place.

Embodiments of the present disclosure provide several practical applications and technical advantages that provide solutions to the problems discussed above in relation to conventional computing systems and networks.

For example, the disclosed system and methods provide the practical application of proactively detecting a data breach within the computing infrastructure and applying one or more remediation methods in to avoid damage (e.g., data theft, compromised computing performance, device failure etc.) to the computing infrastructure because of the data breach.

As described in embodiments of the present disclosure, a security manager may be configured to proactively detect a data breach that has occurred in the computing infrastructure. For example, the security manager monitors a plurality of communication channels that a user may use to communicate with computing nodes of a computing infrastructure and detect when a data interaction is initiated or performed by a user using one of the communication channels. The security manager is configured to determine whether a data interaction initiated and/or performed by a user or in relation to a user amounts to a data breach. For example, when an unauthorized user accesses a computing node (e.g., a data server), the security manager is configured to detect this event as a data breach. In response to detecting that a data interaction has been initiated or performed in relation to a user, the security manager determines, based on an interaction log associated with the data interaction and historical interaction logs associated with previous data interactions performed in relation to the user, whether a potential data breach has occurred. For example, the security manager compares the interaction log of the detected data interaction to the historical interaction logs and determines that a potential data breach has occurred when the interaction log at least partially does not match with one or more historical interaction logs.

The security manager then verifies the potential data breach using an AI model to confirm whether the potential data breach actually occurred. The AI model is trained using an interaction behavior pattern associated with the user when performing same or similar data interactions and/or using a knowledge graph that represents previous data interactions performed in relation to the user as logical nodes and relationships between the logical nodes. Upon determining using the AI model that the potential data breach is confirmed, the security manager implements one or more remediation methods (e.g., in real time) to avoid damage to breached computing nodes and systems because of the detected data breach. For example, one or more remediation methods may be configured to avoid or prevent theft of data from a breached data server.

Thus, unlike conventional systems where a data breach is detected after damage to computing systems has taken place, the disclosed system and methods proactively detect a data breach and implement remediation methods that stop damage or further damage from occurring because of the data breach. For example, as disclosed in embodiments of the present disclosure, the security manager is configured to determine computing nodes and systems that are impacted due to the detected data breach and apply specific remediation methods to avoid damage to the impacted computing nodes and systems. For example, upon detecting that a data breach may result in unauthorized access to a data server, the security manager may implement a zero-trust remediation method that prompts users to provide authorization credentials to perform each process performed by the breached data server or access each piece of data (e.g., webpage, data table, data file etc.) stored at the server. This avoids a bad actor from gaining access to the data server and from installing malware at the data server. By avoiding a malware attack at the data server, the disclosed system and method avoid damage to the data server that may otherwise occur due to malware installed at the data server. For example, avoiding a malware attack may avoid several types of damage typically caused by a malware attack including, but not limited to, compromised computing performance including slow processor performance, browser redirects, frequent infection warnings, frequent pop-up ads, problems starting up and shutting down a computing node, sudden loss of memory disk space, repeated system crashes and freezes, disabled security features, changes in file name and sizes, programs opening and closing themselves, or a combination thereof. In addition, by not allowing unauthorized access to a breached data server, the disclosed system and method avoid or prevent a bad actor from gaining unauthorized access to other computing nodes and systems that are communicatively coupled to the breached data server, and thus avoid damage to those other computing nodes and systems. Thus, by avoiding malware attacks on computing nodes and systems, the disclosed system and methods improve performance of those computing nodes and systems.

In another example, in response to detecting that a data server has been breached, the security manager may implement a remediation method that automatically encrypts sensitive data stored at the data server. This avoids an unauthorized bad actor from stealing and/or exfiltrating sensitive data from the data server. Thus, the disclosed system and methods improve data security associated with a computing network.

Thus, the disclosed system and method generally improve the technology associated with data security of computing networks.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure; and

FIG. 2 illustrates an example system for detecting a data breach and implementing remediation methods, in accordance with certain embodiments of the present disclosure.

### DETAILED DESCRIPTION

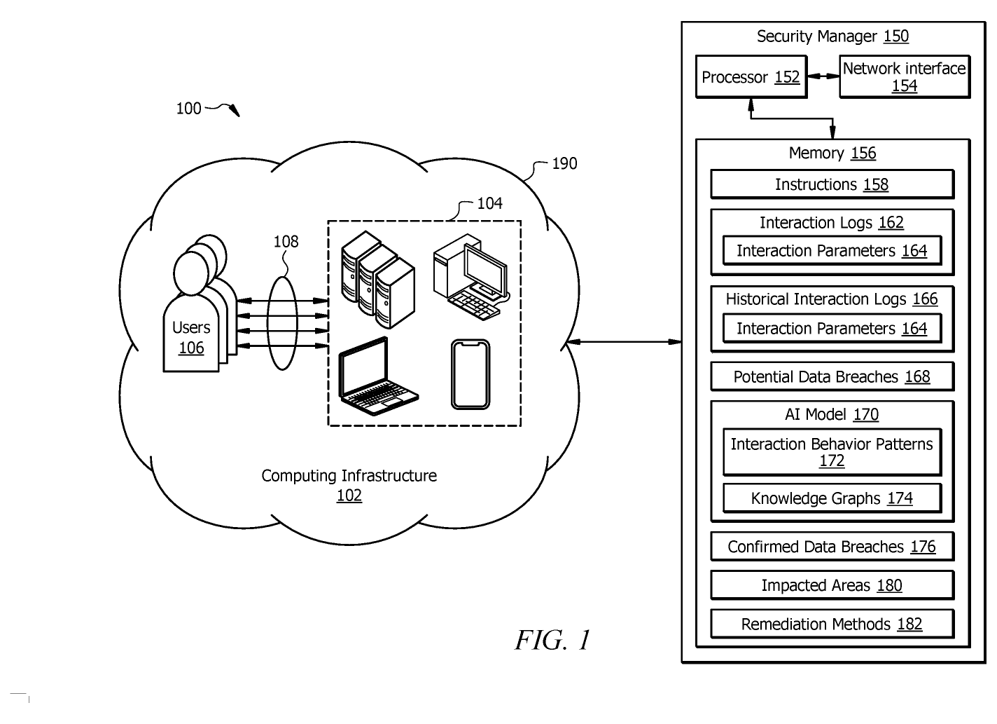

FIG. 1 is a schematic diagram of a system 100, in accordance with certain aspects of the present disclosure. As shown, system 100 includes a computing infrastructure 102 connected to a network 190. Computing infrastructure 102 may include a plurality of hardware and software components. The hardware components may include, but are not limited to, computing nodes 104 such as desktop computers, smartphones, tablet computers, laptop computers, data servers and data centers, mainframe computers, virtual reality (VR) headsets, augmented reality (AR) glasses and other hardware devices such as printers, routers, hubs, switches, and memory all connected to the network 190. Software components may include software applications that are run by one or more of the computing nodes 104 including, but not limited to, operating systems, user interface applications, third party software, database management software, service management software, mainframe software, metaverse software, AI tools and other customized software programs (e.g., security manager 150) implementing particular functionalities. For example, software code relating to one or more software applications may be stored in a memory device and one or more processors (e.g., belonging to one or more computing nodes 104) may execute the software code to implement respective functionalities. An example software application run by one or more computing nodes 104 of the computing infrastructure 102 may include the security manager 150. In one embodiment, at least a portion of the computing infrastructure 102 may be representative of an Information Technology (IT) infrastructure of an organization.

One or more of the computing nodes 104 may be operated by a user 106. In this context, a computing node 104 operated by a user may be referred to as a user device. For example, a computing node 104 may provide a user interface using which a user 106 may operate the computing node 104 to perform data interactions within the computing infrastructure 102. The term “computing node 104” may be replaced by “user device” in this disclosure when the computing node 104 is operated by a user 106.

One or more computing nodes 104 of the computing infrastructure 102 may be representative of a computing system which hosts software applications that may be installed and run locally or may be used to access software applications running on a server. The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server running one or more software applications to implement respective functionality as described below. In certain embodiments, one or more of the computing nodes 104 may run a thin client software application where the processing is directed by the thin client but largely performed by a central entity such as a server (not shown).

Network 190, in general, may be a wide area network (WAN), a personal area network (PAN), a cellular network, or any other technology that allows devices to communicate electronically with other devices. In one or more embodiments, network 190 may be the Internet.

As described above, a user 106 may operate a computing node 104 (e.g., a personal computer) to perform a data interaction within the computing infrastructure 102. For example, a user 106 may operate a user device (e.g., one of the computing nodes 104) to perform a particular data interaction within the computing infrastructure 102. Data interactions that may be performed in the computing infrastructure 102 may include accessing data stored in a memory device (e.g., database or server) of the computing infrastructure 102, processing data by a processing server of the computing infrastructure 102, transmission of data between computing nodes 104 of the computing infrastructure 102, or a combination thereof. In one example, a data interaction may include a user 106 logging into a user profile (e.g., a social media profile, a content streaming profile, an email profile etc.) to gain access to data (e.g., social media data feed, video content, emails etc.) stored on a respective data server. In one example, a data interaction may include a user 106 requesting a piece of data stored on a database or server (e.g., a computing node 104) of the computing infrastructure 102 and receiving the requested data at a user device (e.g., another computing node 104). For example, the user 106 may use a webmail application running on the user device to request and receive email data from an email server. In another example, a data interaction requested by a user 106 using a user device may include data transmission from a first computing node 104 to a second computing node 104 of the computing infrastructure 102. For example, sending an email by a first user to a second user may include transmission of email data from a first email server associated with the first user to a second email server associated with the second user. Performing a data interaction within the computing infrastructure 102 may include accessing, processing, and or transmission of sensitive data including, but not limited to, Non-Public Information (NPI), Personal Identification Information (PII), Production Information, or any other data that is designated as sensitive data.

Often computing systems (e.g., computing nodes 104) that store, process, or handle sensitive data in some manner are prone to cyber-attacks or data breaches in which a hacker gains unauthorized access to the computing systems and data stored on the computing systems. The term “cyber-attack” is often used interchangeably with the term “data breach” and refers to any security incident in which unauthorized parties access computing systems and sensitive or confidential information, including but not limited to, Non-Public Information (NPI), Personal Identification Information (PII), Production Information, or any other data that is designated as sensitive data. In one example, a data breach may include unauthorized installing of malicious software code (e.g., malware) at a computing device (e.g., data server), wherein the malicious software is configured to perform malicious activities to disrupt an operation of the computing device, for example, by creating unwanted files to slow down the speed and performance of the computing device, corrupting files, or crashing some software or executable applications so that they cannot be executed. A malware can infect many types of devices, including cell phones, computers, tables, and smart televisions. It usually spreads by duplicating itself and hiding in a device’s data files. A malware attack often results in compromised computing performance by causing slow processor performance, browser redirects, frequent infection warnings, frequent pop-up ads, problems starting up and shutting down a computing node, sudden loss of memory disk space, repeated system crashes and freezes, disabled security features, changes in file name and sizes, programs opening and closing themselves, or a combination thereof. In some cases, a malware locks up networks and computing nodes making them unusable. In another example, a data breach may include access to sensitive data, such as personal information without authorization. In another example, a data breach may exfiltrate data by transmitting confidential data to unauthorized devices. In some cases, the stolen data may be used to perform other unauthorized data interactions within the computing infrastructure and to gain access to other computing nodes.

Bad actors use several techniques to gain unauthorized access to computing systems. For example, a bad actor may engage in a phishing attack to steal sensitive user information. A phishing attack may include the bad actor sending a text message to a user purporting to be from a reputable organization in order to induce the user to reveal personal information such as passwords to user profiles. In one example, a bad actor may send a text message to a user’s smart phone purporting to be from an email provider of the user. The text message may include a link to a webpage that looks like a login screen of the email provider. Upon, clicking the link from the text message, the user is re-directed to the webpage where the user is induced to enter a username and password of the user’s email profile. This allows the bad actor to gain access to the user’s emails and use sensitive data included in the user’s emails to gain access to other computing systems. For example, the bad actor may gain access to an email that includes membership details of a video streaming service, which allows the bad actor to gain access to a streaming server.

In some cases, the computing infrastructure may support a plurality of communication channels 108 using which a user 106 may perform data interactions within the computing infrastructure 102. For example, a service provider may support several communication channels 108 including, but not limited to, email, social media, mobile application, web application, or a combination thereof. In some cases, a bad actor may hack a first communication channel 108 and use information stolen from the first communication channel 108 to gain access to one or more other communication channels. For example, as described above, the bad actor may steal login credential to a user’s email profile using a phishing attack and steal user’s personal information (e.g., social security number, residential address, phone number, service membership number etc.) from the user’s emails. This information may then be used by the bad actor to gain access to the user’s service membership (e.g., a video streaming service) via a mobile application or web application. Once the bad actor gains access to a data server using any of these methods, the bad actor may install malware at the data server to compromise the performance of the data server and/or steal sensitive data stored at the data server.

Conventional systems generally implement a reactive approach to detecting and remediating data breaches. For example, conventional systems lack the capability to detect data breaches when they are actively taking place. Further, conventional systems cannot apply security measures that avoid or prevent the data breach from causing damage (e.g., data theft, compromised computing performance, device failure etc.) to computing systems.

Embodiments of the present disclosure discuss techniques to proactively detect a data breach within the computing infrastructure 102 and apply one or more remediation methods in real time to avoid any further damage to the computing infrastructure 102 because of the data breach.

At least a portion of the computing infrastructure 102 (e.g., one or more computing nodes 104) may implement a security manager 150 which may be configured to implement techniques for proactively detecting a data breach in a computing network (e.g., computing infrastructure 102) and implementing remediation measures to avoid damage from the data breach. The security manager 150 includes a processor 152, a memory 156, and a network interface 154. The security manager 150 may be configured as shown in FIG. 1 or in any other suitable configuration.

The processor 152 includes one or more processors operably coupled to the memory 156. The processor 152 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

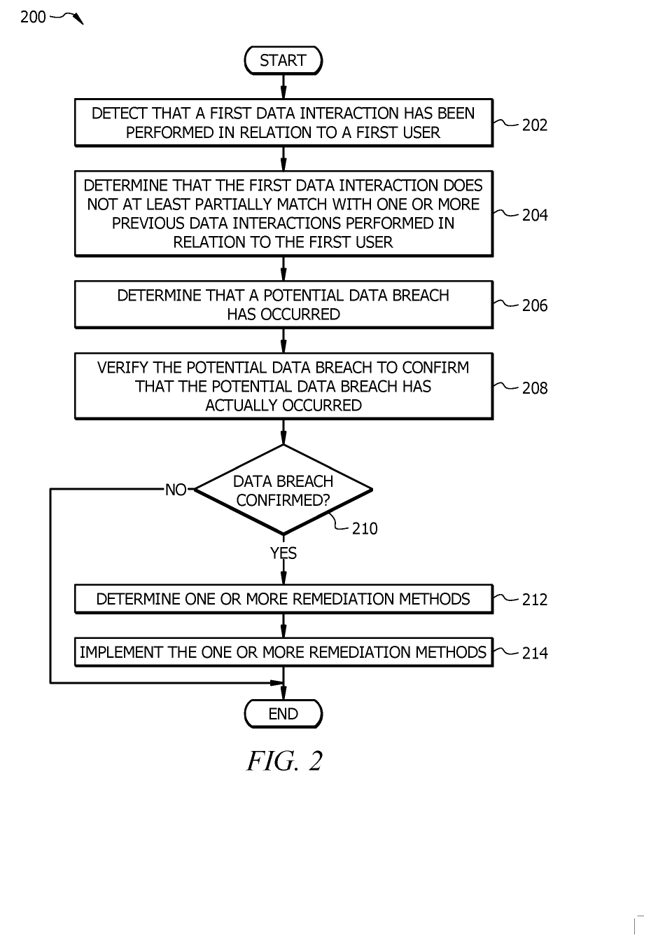

The one or more processors are configured to implement various instructions, such as software instructions. For example, the one or more processors are configured to execute instructions 158 to implement the security manager 150. In this way, processor 152 may be a special-purpose computer designed to implement the functions disclosed herein. In one or more embodiments, the security manager 150 is implemented using logic units, FPGAs, ASICs, DSPs, or any other suitable hardware. The security manager 150 is configured to operate as described with reference to FIGS. 1 and 2. For example, the processor 152 may be configured to perform at least a portion of method 200 as described with reference to FIG. 2 respectively.

The memory 156 includes a non-transitory computer-readable medium such as one or more disks, tape drives, or solid-state drives, and may be used as an over-flow data storage device, to store programs when such programs are selected for execution, and to store instructions and data that are read during program execution. The memory 156 may be volatile or non-volatile and may include a read-only memory (ROM), random-access memory (RAM), ternary content-addressable memory (TCAM), dynamic random-access memory (DRAM), and static random-access memory (SRAM).

The memory 156 is operable to store the instructions 158, interaction logs 162 (including interaction parameters 164) associated with data interactions performed in the computing infrastructure 102, historical interaction logs 166 (including interaction parameters 164) associated with previous data interactions performed in the computing infrastructure 102, potential data breaches 168 detected by the security manager 150, artificial intelligence (AI) model 170 including interaction behavior patterns 172 and knowledge graphs 174, confirmed data breaches 176, impact areas 180 of a data breach 168/176, remediation methods 182, and any other data needed to performed operations of the security manager 150 as described in embodiments of the present disclosure. The instructions 158 may include any suitable set of instructions, logic, rules, or code operable to execute the security manager 150.

The network interface 154 is configured to enable wired and/or wireless communications. The network interface 154 is configured to communicate data between the security manager 150 and other devices, systems, or domains (e.g., computing nodes 104). For example, the network interface 154 may include a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

It may be noted that each of the computing nodes 104 may be implemented like the security manager 150 shown in FIG.1. For example, each of the computing nodes 104 may have a respective processor and a memory that stores data and instructions to perform a respective functionality of the computing node 104.

The security manager 150 may be configured to proactively detect a data breach (e.g., potential data breach 168 and/or confirmed data breach 176) that has occurred in the computing infrastructure 102. For example, the security manager 150 may be configured to monitor each of a plurality of communication channels 108 for data interactions performed by users 106. Thus, when a data interaction is initiated and/or performed by a user 106 using one of the communication channels 108, the security manager 150 detects, in real time, that a data interaction in relation to the user 106 has been initiated and/or performed. It may be noted that a data interaction relating to a particular authorized user 106 may be initiated and/or performed by another user (e.g., a hacker) pretending to be the authorized user 106. For example, as described above, a bad actor may gain access to an authorized user’s login credentials (e.g., username, password etc.) via a phishing attack and may then use the login credentials to access one or more data servers within the computing infrastructure 102. As described in further detail below, when an unauthorized user accesses a computing node 104 (e.g., a data server), the security manager 150 is configured to detect this event as a data breach.

In one or more embodiments, each data interaction performed in the computing infrastructure 102 is associated with an interaction log 162 that includes a plurality of interaction parameters 164 recording information relating to the data interaction, wherein the interaction parameters 164 include, but are not limited to, identity of a user 106 that initiated/performed the data interaction, authorization credentials (e.g., username, password etc.) of the user 106, a type of the data interaction (e.g., data access, data transfer etc.), a device ID of a computing node (e.g., user device) that was used to initiate the data interaction, an internet protocol (IP) address of the computing node, a network ID of the network (e.g., Local Area Network (LAN)) to which the computing node is connected to, device ID of a network router using which the computing node is communicating with the network 190, a device ID and IP address of the computing node that is being accessed by the user device, information relating to intermediate computing nodes that are involved in performing the data interaction, and any other information relating to the data interaction. An interaction log 162 is automatically generated (e.g., by a designated computing node 104 within the computing infrastructure 102) for each data interaction performed in the computing infrastructure 102. The security manager 150 has access in real time to interaction logs 162 associated with data interactions being conducted in the computing infrastructure 102 or shortly after being conducted in the computing infrastructure.

In one or more embodiments, the security manager 150 also has access to historical interaction logs 166 of previous data interactions conducted in the computing infrastructure 102, wherein each historical interaction log 166 is an interaction log 162 associated with a data interaction that was conducted in the past and includes interaction parameters 164 as described above associated with the previously performed data interaction.

In one or more embodiments, the security manager 150 may be configured to determine whether a detected data interaction is associated with a data breach. The security manager 150 may be configured to check whether a data breach has occurred in relation to the data interaction in two steps. In a first step, the security manager 150 uses minimal computing resources to quickly determine whether a potential data breach 168 has occurred. Once it is determined that a potential data breach 168 has occurred, the security manager 150, in a second step, uses a more elaborate process to verify the potential data breach 168 and confirm whether the potential data breach 168 corresponds to an actual data breach (e.g., confirmed data breach 176). The first process serves as a quick check that uses smaller amount of computing resources to detect whether any potential data breaches 168 have occurred. The second, more elaborate, process which uses a higher amount of computing resources is performed only in cases where a potential data breach 168 is detected. This two-step approach to detecting data breaches saves computing resources by not needing to perform the more elaborate second process to analyze every data interaction for data breaches.

As part of the first process of detecting potential data breaches 168, in response to detecting that a data interaction has been initiated or performed in relation to a user 106, the security manager 150 accesses (e.g., in real time) the interaction log 162 associated with the detected data interaction. For example, when the login credentials of the user 106 are used to login to a mobile application, the security manager 150 detects the login as a data interaction in relation to the user 106 and accesses the interaction log 162 associated to the login event. In another example, when a user 106 initiates data transfer from a user device (e.g., a first computing node 104) to second computing node 104 of the computing infrastructure 102, the security manager 150 detects the data transfer as a data interaction in relation to the user 106 and accesses the interaction log 162 associated with the data transfer. The first process of detecting whether a potential data breach 168 has occurred includes comparing the detected data interaction with one or more previous data interactions performed in the computing infrastructure 102 and determining whether a potential data breach 168 has occurred based on an extent of match between the detected data interaction and the one or more previous data interactions. In this context, the security manager 150 identifies one or more historical interaction logs 166 that are associated with previous data interactions performed in relation to the same user 106 (e.g., user that performed the detected data interaction) and are same or similar to the detected data interaction. The security manager 150 may be configured to compare the interaction log 162 associated with the detected data interaction with the identified one or more historical interaction logs 166. The security manager 150 may be configured to determine whether the detected data interaction relates to a potential data breach 168 based on an extent of match between the interaction log 162 of the detected data interaction and the identified one or more historical interaction logs 166 of the previous data interactions. For example, the security manager 150 may be configured to determine that a potential data breach 168 has occurred when the interaction log 162 at least partially does not match with one or more of the historical interaction logs 166. For example, the comparison of the interaction log 162 with a historical interaction log 166 may be a simple text comparison of the two logs. The security manager 150 may determine that a potential data breach 168 has occurred when at least a threshold amount of text does not match between the two interaction logs. In other words, the security manager 150 determines that a data breach has occurred when the detected data interaction at least partially does not match with one or more previously performed data interactions that are same or similar to the detected data interaction.

Once it is determined that the detected data interaction relates to a potential data breach 168, the security manager 150 may be configured to perform the second more elaborate process, as part of the second step, to verify the potential data breach 168 and confirm whether the potential data breach 168 relates to an actual data breach (e.g., confirmed data breach 176). In one embodiment, the security manager 150 is configured to use an AI model 170 that is trained to verify the potential data breach 178. The AI model 170 may be trained to verify a potential data breach 168 based on one or more interaction behavior patterns 172 and one or more knowledge graphs 174. Each interaction behavior pattern 172 is associated with a particular type of data interaction (e.g., logging into a mobile/web application, transfer data etc.) performed by a particular user 106 and includes a set of interaction parameters 164 typically associated with the particular type of data interaction when performed by the particular user 106. The set of interaction parameters 164 represents a repetitive behavior pattern of the particular user 106 when performing the particular type of data interaction. For example, a set of interaction parameters 164 associated with an interaction behavior pattern 172 of a particular user when logging into a web application may include a device ID of a particular computing node 104 (e.g., a desktop computer) that the particular user 106 typically uses to login to the web application, an IP address of the particular computing node 104, a network ID of the network (e.g., LAN) to which the particular computing node 104 is typically connected to when performing this data interaction, and a device ID of a network router using which the particular computing node 104 typically communicates with the network 190.

In one embodiment, the security manager 150 may be configured to generate each interaction behavior pattern 172 associated with a particular type of data interaction performed by a particular user 106, based on a plurality of historical interaction logs 166 associated with respective same or similar data interactions previously performed by the particular user 106. For example, the security manager 150 may be configured to identify a common set of interaction parameters 164 across the plurality of historical interaction logs 166 and designate the identified set of interaction parameters 164 as the interaction behavior pattern 172 associated with the particular data interaction performed by the particular user. In one embodiment, the security manager 150 may store or have access to a plurality of interaction behavior patterns 172 for each of a plurality of users 106, wherein each interaction behavior pattern 172 associated with a particular user 106 represents a behavior pattern 172 of the particular user 106 when performing a different type of data interaction. In one embodiment, the security manager 150 may use a machine learning algorithm (e.g., AI algorithm) to generate interaction behavior patterns 172 based on historical interaction logs 166.

A knowledge graph 174 is a data model that represents previous data interactions performed in relation to a particular user as a plurality of data nodes and relationships between the data nodes. The term “knowledge graph” in AI refers to a structured data model that represents real-world entities (like people, places, or concepts) and the relationships between them, essentially creating a network of interconnected information, often visualized as a graph, where nodes represent entities and edges represent the connections/relationships between them. A knowledge graph allows AI systems (e.g., AI model 170) to understand context and relationships within data, enabling more accurate and insightful analysis and reasoning. In the context of the present disclosure, each previous data interaction performed by a particular user 106 may be represented in the knowledge graph 174 as a set of nodes and relationships between the nodes. For example, in relation to a particular data interaction including transfer of data between a user device to a data server of the computing infrastructure 102, a first node of the knowledge graph 174 may represent the user device, a second node of the knowledge graph 174 may represent the data server and the edge/relationship between the first and second nodes may represent transfer of data between the user device and the data server.

As described above, the security manager 150 may be configured to train the AI model 170 to verify a potential data breach 168 based on one or more interaction behavior patterns 172, one or more knowledge graphs 174, or a combination thereof. When a potential data breach 168 is identified as described above, the security manager 150 may be configured to input to the AI model 170 the interaction log 162 associated with the data interaction based on which the potential data breach 168 was identified. In an additional embodiment, the security manager 150 may input information relating to the potential data breach 168. The AI model 170 may process the interaction log 162 based on one or more interaction behavior patterns 172 and/or one or more knowledge graphs 174 and output as result an indication of whether the potential data breach 168 is a confirmed data breach 176. In other words, the AI model 170 determines whether the potential data breach 168 is an actual data breach.

In one embodiment, based on the interaction log 162 of the detected data interaction, AI model 170 may determine a unique user ID of the user 106 to which the data interaction belongs, and a type of data interaction performed in relation to the user 106. The AI model 170 may then obtain an interaction behavior pattern 172 associated with the user 106 and the identified type of data interaction. The AI model 170 may then extract a set of interaction parameters 164 from the interaction log 162 of the data interaction that corresponds to the set of interaction parameters 164 associated with the interaction behavior pattern 172. The AI model 170 compares the two sets of interaction parameters and determines whether the potential data breach has actually occurred. For example, the AI model 170 determines that the potential data breach 168 is a confirmed data breach 176 when at least a threshold number of interaction parameters 164 do not match between the two sets. On the other hand, the AI model 170 determines that the potential data breach 168 is not confirmed (e.g., is not a confirmed data breach 176) when at least a threshold number of interaction parameters 164 match between the two sets. For example, when both the device ID and network ID from the interaction behavior pattern 172 does not match with the corresponding device ID and network ID extracted from the interaction log 162 of the data interaction, the AI model 170 determines that the potential data breach 168 is a confirmed data breach 176. This means a different user device connected to a different network was used to perform the data interaction than what the user 106 typically uses to perform the same type of data interaction.

In an alternative or additional embodiment, the AI model 170 may identify/obtain a knowledge graph 174 representing previous data interactions performed by the same user 106 to which the data interaction belongs, wherein the previous data interactions are same or similar to the detected data interaction. The AI model 170 may analyze the interaction log 162 associated with the detected data interaction in view of the knowledge graph 174 and determine whether the potential data breach has actually occurred based on this analysis. For example, the AI model 170 determines that the potential data breach 168 is a confirmed data breach 176 when the data interaction does not match with at least a threshold number of nodes and the corresponding relationships between the nodes from the knowledge graph 174. On the other hand, the AI model 170 determines that the potential data breach 168 is not confirmed (e.g., is not a confirmed data breach 176) when the data interaction matches with at least a threshold number of nodes and the corresponding relationships between the nodes from the knowledge graph 174.

In one or more embodiments, the security manager may be configured to determine one or more impacted areas 180 associated with the detected data breach (e.g., potential data breach 168/confirmed data breach 176). The impacted areas 180 may include, but are not limited to, computing systems (e.g., including one or more computing nodes 104), communication channels 108, software services/processes associated with the computing infrastructure 102, and software applications hosted by computing nodes 104 of the computing infrastructure 102. The security manager 150 may be configured to perform one or more of a plurality of diagnosis methods to determine one or more impacted areas 180 associated with the determined data breach. These diagnosis methods may include dependency analysis, network analysis, event correlation and log analysis. An impacted area 180 may represent a potential or actual secondary data breach and/or compromised performance because of the primary data breach.

Dependency analysis may include analyzing dependencies between software services/processes/applications and determining one or more software services/processes/applications that may be impacted because of the detected data breach. Typically, dependencies exist between software processes/applications. A dependency between two processes/applications generally means that at least a portion of one process/application is dependent on data received from another process/application. For example, a product procurement process/application may have built in dependencies with an inventory management process/application. A data breach associated with a first process/application may impact a second process/application that is dependent on the first process/application, and vice versa. When a data breach associated with a first process/application is detected, the security manager 150 determines all other processes/applications that have inter-dependencies with the first process/application and designates those processes/applications as impacted areas 180.

Network analysis may include analyzing computing nodes 104 that are communicatively coupled to a particular computing node 104 associated with a detected data breach and determining one or more computing nodes 104 that may be impacted because of the detected data breach. A computing node 104 may be communicatively coupled to one or more other computing nodes 104 of the computing infrastructure 102. For example, these computing nodes 104 may be part of the same private network (e.g., LAN, virtual private network etc.). In such cases, it is possible that a bad actor that has gained access to a particular computing node 104, may also gain unauthorized access to other computing nodes 104 that are communicatively coupled to the particular computing node 104. When a data breach associated with a first computing node 104 is detected, the security manager 150 determines one or more other computing nodes 104 that are communicatively coupled to the first computing node 104 and determines that the one or more other computing nodes are potential impacted areas 180.

Event correlation includes analyzing correlated events in view of the detected data breach and determining whether interdependent events can potentially be impacted. For example, a detected data breach at a first computing node 104 processing a first event may impact one or more other events being processed by the same computing node 104 or other computing nodes 104. For example, a first computing node processing login event webpages may be connected to a second computing node processing verification events and a third computing node generating audit logs. In this case, a breach of the login event impacts the second and third events as well. When a data breach associated with a first event is detected, the security manager 150 determines one or more other events that are associated (e.g., interdependent) with the first event and determines that the one or more other events are potential impacted areas 180.

Log analysis includes analyzing interaction log 162 of the data interaction associated with a detected data breach and determining one or more impacted areas 180 based on the information included in the interaction log 162. For example, the interaction log 162 of the compromised data interaction may include sensitive information (e.g., user credentials, names, residential address, IP address, device IDs etc.) that may be used by a bad actor to gain access to other computing nodes and communication channels. The security manager 150 may be configured to analyze the information included in the interaction log 162 of the compromised data interaction and determine what other computing systems and/or communication channels may be breached using the information included in the interaction log 162. The security manager 150 then designates those other computing systems and communication channels as impacted areas 180.

In one or more embodiments, once a data breach is confirmed (e.g., confirmed data breach detected), the security manager 150 may be configured to determine and apply one or more remediation methods 182 (e.g., in real time) to avoid damage (e.g., theft of data, compromised functioning or malfunction of computing systems etc.) because of the detected data breach. One example remediation method 182 may include implementing a zero-trust architecture in which authentication credentials are needed to perform every process/step. For example, when a data breach of data server is detected, security manager 150 may implement zero-trust architecture that prompts a user to enter pre-registered credentials (e.g., password, one time password (OTP) etc.) for opening webpages within a website hosted by the breached data server, or for accessing specific documents or data stored at the breached data server.

Another example remediation method 182 includes requesting additional verification to perform a requested data interaction, upon detecting a data breach. For example, when data transfer initiated by a user is determined to have been compromised, the security manager 150 may prompt the user to provide an additional authentication credential (e.g., a pin sent via text message to the user’s phone, answer to a security question etc.) to verify the data interaction. The data interaction is processed only upon successful verification of the additional authentication credential.

Another example remediation method 182 applies to phishing attacks and includes stopping a phishing email from being forwarded to other users, and/or forwarding the suspected phishing email to a security team for validation.

Another example remediation method 182 includes dynamically initiating multi-factor authentication relating to a data interaction that is detected to have been breached. The data interaction is processed only upon successfully performing the multi-factor authentication.

Another example remediation method 182 includes sending automatic alerts to a user and/or security team when a data interaction relating to a user is detected and determined to have been breached. An alert allows the user to learn that a data interaction relating to the user has been initiated and allows the user to take action to protect against damage (e.g., theft of data, compromised computing nodes etc.) because of the data breach.

Another example remediation method 182 includes automatically encrypting sensitive data in response to detecting a data breach. For example, in response to detecting that a database server has been breached, the security manager 150 may encrypt sensitive data stored at the breached data server so that a hacker cannot gain access to the sensitive data.

In one or more embodiments, the security manager 150 may be configured to determine one or more of the remediation methods 182 that are to be applied based on the detected data breach (e.g., confirmed data breach 176). For example, the security manager 150 may be configured to determine one or more remediation methods 182 that are be applied (e.g., in real time) to avoid damage because of the detected data breach. The security manager 150 may determine the one or more remediation methods 182 based on the nature/type of the data interaction that has been breached, one or more impacted areas 180, a severity of the data breach, or a combination thereof. For example, when an impacted area 180 because of a data breach is a web server, the security manager 150 may implement zero-trust architecture for access of websites hosted by the web server. When sensitive data is stored at the breached web server, the security manager 150 may additionally implement automatic encryption of the sensitive stored at the web server.

In another example, in response to detecting a phishing email to a user’s email profile, the security manager 150 may implement the remediation method 182 described above to stop the phishing email from being forwarded to other users. Additionally, the security manager 150 may automatically encrypt sensitive user data stored at an email server that can be impacted as a result of the data breach.

In one or more embodiments, in response to detecting a first data breach associated with a first communication channel 108, the security manager 150 may be configured to avoid a second data breach that may occur in relation to a second communication channel because of the first data breach. For example, upon detecting a phishing email to a user’s email profile which the user uses to communicate with an entity, the security manager 150 may determine that an impacted area 180 associated with the phishing attack may be a web server that serves as another communication channel 108 for the user to communicate with the entity. For example, the entity may send emails to the user’s email profile relating to a service and provide the user access to a user profile of the user via a web application hosted at the web server. A bad actor may use the email phishing attack to gain access to login credentials that the user uses to login to the web application. In response to determining that the web server is an impacted area 180, the security manager 150 automatically encrypts sensitive information stored at the web server to avoid data theft.

FIG. 2 illustrates an example system for detecting a data breach and implementing remediation methods, in accordance with certain embodiments of the present disclosure. Method 200 may be performed by the security manager 150 shown in FIG. 1.

At operation 202, the security manager 150 detects that a first data interaction has been performed in relation to a first user 106.

As described above, the security manager 150 may be configured to proactively detect a data breach (e.g., potential data breach 168 and/or confirmed data breach 176) that has occurred in the computing infrastructure 102. For example, the security manager 150 may be configured to monitor each of a plurality of communication channels 108 for data interactions performed by users 106. Thus, when a data interaction is initiated and/or performed by a user 106 using one of the communication channels 108, the security manager 150 detects, in real time, that a data interaction in relation to the user 106 has been initiated and/or performed. It may be noted that a data interaction relating to a particular authorized user 106 may be initiated and/or performed by another user (e.g., a hacker) pretending to be the authorized user 106. For example, as described above, a bad actor may gain access to an authorized user’s login credentials (e.g., username, password etc.) via a phishing attack and may then use the login credentials to access one or more data servers within the computing infrastructure 102. As described in further detail below, when an unauthorized user accesses a computing node 104 (e.g., a data server), the security manager 150 is configured to detect this event as a data breach.

At operation 204, the security manager 150 determines, based on one or more historical interaction logs 166 associated with the previous data interactions performed in relation to the first user 106, that the first data interaction does not at least partially match with the previous data interactions performed in relation to the first user 106.

At operation 206, in response to determining that the first data interaction does not at least partially match with the previous data interactions performed in relation to the first user 106, the security manager 150 determine that a potential data breach 168 has occurred.

As described above, each data interaction performed in the computing infrastructure 102 is associated with an interaction log 162 that includes a plurality of interaction parameters 164 recording information relating to the data interaction, wherein the interaction parameters 164 include, but are not limited to, identity of a user 106 that initiated/performed the data interaction, authorization credentials (e.g., username, password etc.) of the user 106, a type of the data interaction (e.g., data access, data transfer etc.), a device ID of a computing node (e.g., user device) that was used to initiate the data interaction, an internet protocol (IP) address of the computing node, a network ID of the network (e.g., Local Area Network (LAN)) to which the computing node is connected to, device ID of a network router using which the computing node is communicating with the network 190, a device ID and IP address of the computing node that is being accessed by the user device, information relating to intermediate computing nodes that are involved in performing the data interaction, and any other information relating to the data interaction. An interaction log 162 is automatically generated (e.g., by a designated computing node 104 within the computing infrastructure 102) for each data interaction performed in the computing infrastructure 102. The security manager 150 has access in real time to interaction logs 162 associated with data interactions being conducted in the computing infrastructure 102 or shortly after being conducted in the computing infrastructure.

In one or more embodiments, the security manager 150 also has access to historical interaction logs 166 of previous data interactions conducted in the computing infrastructure 102, wherein each historical interaction log 166 is an interaction log 162 associated with a data interaction that was conducted in the past and includes interaction parameters 164 as described above associated with the previously performed data interaction.

As part of the first process of detecting potential data breaches 168, in response to detecting that a data interaction has been initiated or performed in relation to a user 106, the security manager 150 accesses (e.g., in real time) the interaction log 162 associated with the detected data interaction. For example, when the login credentials of the user 106 are used to login to a mobile application, the security manager 150 detects the login as a data interaction in relation to the user 106 and accesses the interaction log 162 associated to the login event. In another example, when a user 106 initiates data transfer from a user device (e.g., a first computing node 104) to second computing node 104 of the computing infrastructure 102, the security manager 150 detects the data transfer as a data interaction in relation to the user 106 and accesses the interaction log 162 associated with the data transfer. The first process of detecting whether a potential data breach 168 has occurred includes comparing the detected data interaction with one or more previous data interactions performed in the computing infrastructure 102 and determining whether a potential data breach 168 has occurred based on an extent of match between the detected data interaction and the one or more previous data interactions. In this context, the security manager 150 identifies one or more historical interaction logs 166 that are associated with previous data interactions performed in relation to the same user 106 (e.g., user that performed the detected data interaction) and are same or similar to the detected data interaction. The security manager 150 may be configured to compare the interaction log 162 associated with the detected data interaction with the identified one or more historical interaction logs 166. The security manager 150 may be configured to determine whether the detected data interaction relates to a potential data breach 168 based on an extent of match between the interaction log 162 of the detected data interaction and the identified one or more historical interaction logs 166 of the previous data interactions. For example, the security manager 150 may be configured to determine that a potential data breach 168 has occurred when the interaction log 162 at least partially does not match with one or more of the historical interaction logs 166. For example, the comparison of the interaction log 162 with a historical interaction log 166 may be a simple text comparison of the two logs. The security manager 150 may determine that a potential data breach 168 has occurred when at least a threshold amount of text does not match between the two interaction logs. In other words, the security manager 150 determines that a data breach has occurred when the detected data interaction at least partially does not match with one or more previously performed data interactions that are same or similar to the detected data interaction.

At operation 208, the security manager 150 verifies the potential data breach 168 to confirm whether the potential data breach 168 has actually occurred.

As described above, once it is determined that the detected data interaction relates to a potential data breach 168, the security manager 150 may be configured to perform the second more elaborate process, as part of the second step, to verify the potential data breach 168 and confirm whether the potential data breach 168 relates to an actual data breach (e.g., confirmed data breach 176). In one embodiment, the security manager 150 is configured to use an AI model 170 that is trained to verify the potential data breach 178. The AI model 170 may be trained to verify a potential data breach 168 based on one or more interaction behavior patterns 172 and one or more knowledge graphs 174. Each interaction behavior pattern 172 is associated with a particular type of data interaction (e.g., logging into a mobile/web application, transfer data etc.) performed by a particular user 106 and includes a set of interaction parameters 164 typically associated with the particular type of data interaction when performed by the particular user 106. The set of interaction parameters 164 represents a repetitive behavior pattern of the particular user 106 when performing the particular type of data interaction. For example, a set of interaction parameters 164 associated with an interaction behavior pattern 172 of a particular user when logging into a web application may include a device ID of a particular computing node 104 (e.g., a desktop computer) that the particular user 106 typically uses to login to the web application, an IP address of the particular computing node 104, a network ID of the network (e.g., LAN) to which the particular computing node 104 is typically connected to when performing this data interaction, and a device ID of a network router using which the particular computing node 104 typically communicates with the network 190.

In one embodiment, the security manager 150 may be configured to generate each interaction behavior pattern 172 associated with a particular type of data interaction performed by a particular user 106, based on a plurality of historical interaction logs 166 associated with respective same or similar data interactions previously performed by the particular user 106. For example, the security manager 150 may be configured to identify a common set of interaction parameters 164 across the plurality of historical interaction logs 166 and designate the identified set of interaction parameters 164 as the interaction behavior pattern 172 associated with the particular data interaction performed by the particular user. In one embodiment, the security manager 150 may store or have access to a plurality of interaction behavior patterns 172 for each of a plurality of users 106, wherein each interaction behavior pattern 172 associated with a particular user 106 represents a behavior pattern 172 of the particular user 106 when performing a different type of data interaction. In one embodiment, the security manager 150 may use a machine learning algorithm (e.g., AI algorithm) to generate interaction behavior patterns 172 based on historical interaction logs 166.

A knowledge graph 174 is a data model that represents previous data interactions performed in relation to a particular user as a plurality of data nodes and relationships between the data nodes. The term “knowledge graph” in AI refers to a structured data model that represents real-world entities (like people, places, or concepts) and the relationships between them, essentially creating a network of interconnected information, often visualized as a graph, where nodes represent entities and edges represent the connections/relationships between them. A knowledge graph allows AI systems (e.g., AI model 170) to understand context and relationships within data, enabling more accurate and insightful analysis and reasoning. In the context of the present disclosure, each previous data interaction performed by a particular user 106 may be represented in the knowledge graph 174 as a set of nodes and relationships between the nodes. For example, in relation to a particular data interaction including transfer of data between a user device to a data server of the computing infrastructure 102, a first node of the knowledge graph 174 may represent the user device, a second node of the knowledge graph 174 may represent the data server and the edge/relationship between the first and second nodes may represent transfer of data between the user device and the data server.

As described above, the security manager 150 may be configured to train the AI model 170 to verify a potential data breach 168 based on one or more interaction behavior patterns 172, one or more knowledge graphs 174, or a combination thereof. When a potential data breach 168 is identified as described above, the security manager 150 may be configured to input to the AI model 170 the interaction log 162 associated with the data interaction based on which the potential data breach 168 was identified. In an additional embodiment, the security manager 150 may input information relating to the potential data breach 168. The AI model 170 may process the interaction log 162 based on one or more interaction behavior patterns 172 and/or one or more knowledge graphs 174 and output as result an indication of whether the potential data breach 168 is a confirmed data breach 176. In other words, the AI model 170 determines whether the potential data breach 168 is an actual data breach.

In one embodiment, based on the interaction log 162 of the detected data interaction, AI model 170 may determine a unique user ID of the user 106 to which the data interaction belongs, and a type of data interaction performed in relation to the user 106. The AI model 170 may then obtain an interaction behavior pattern 172 associated with the user 106 and the identified type of data interaction. The AI model 170 may then extract a set of interaction parameters 164 from the interaction log 162 of the data interaction that corresponds to the set of interaction parameters 164 associated with the interaction behavior pattern 172. The AI model 170 compares the two sets of interaction parameters and determines whether the potential data breach has actually occurred. For example, the AI model 170 determines that the potential data breach 168 is a confirmed data breach 176 when at least a threshold number of interaction parameters 164 do not match between the two sets. On the other hand, the AI model 170 determines that the potential data breach 168 is not confirmed (e.g., is not a confirmed data breach 176) when at least a threshold number of interaction parameters 164 match between the two sets. For example, when both the device ID and network ID from the interaction behavior pattern 172 does not match with the corresponding device ID and network ID extracted from the interaction log 162 of the data interaction, the AI model 170 determines that the potential data breach 168 is a confirmed data breach 176. This means a different user device connected to a different network was used to perform the data interaction than what the user 106 typically uses to perform the same type of data interaction.

In an alternative or additional embodiment, the AI model 170 may identify/obtain a knowledge graph 174 representing previous data interactions performed by the same user 106 to which the data interaction belongs, wherein the previous data interactions are same or similar to the detected data interaction. The AI model 170 may analyze the interaction log 162 associated with the detected data interaction in view of the knowledge graph 174 and determine whether the potential data breach has actually occurred based on this analysis. For example, the AI model 170 determines that the potential data breach 168 is a confirmed data breach 176 when the data interaction does not match with at least a threshold number of nodes and the corresponding relationships between the nodes from the knowledge graph 174. On the other hand, the AI model 170 determines that the potential data breach 168 is not confirmed (e.g., is not a confirmed data breach 176) when the data interaction matches with at least a threshold number of nodes and the corresponding relationships between the nodes from the knowledge graph 174.

At operation 210, the security manager 150 in response to determining that the potential data breach 168 is not confirmed, meaning that the potential data breach 168 could not be verified, the method 200 ends here. On the other hand, in response to successfully confirming the potential data breach 168 (e.g., determining that the potential data breach 168 is a confirmed data breach 176), method 200 proceeds to operation 212.

At operation 212, the security manager 150 determines one or more remediation methods 182 that are to be used to avoid damage (e.g., theft of data, compromised computing performance etc.) to impacted areas 180 as a result of the data breach.

At operation 214, the security manager 150 implements the one or more remediation methods 182 to avoid damage (e.g., theft of data, compromised computing performance etc.) to impacted areas 180 as a result of the data breach.

As described above, once a data breach is confirmed (e.g., confirmed data breach detected), the security manager 150 may be configured to determine and apply one or more remediation methods 182 (e.g., in real time) to avoid damage (e.g., theft of data, compromised functioning or malfunction of computing systems etc.) because of the detected data breach.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a memory that stores historical interaction logs associated with previous data interactions performed in relation to a first user; and
a processor communicatively coupled to the memory and configured to:
detect that a first data interaction has been performed in relation to the first user;
determine, based on one or more historical interaction logs associated with the previous data interactions, that the first data interaction does not at least partially match with the previous data interactions performed in relation to the first user;
in response to determining that the first data interaction does not at least partially match with the previous data interactions performed in relation to the first user, determine that a data breach has potentially occurred;
verify the data breach to confirm whether the data breach has occurred, wherein the verifying comprises one or more of:
determining whether the first data interaction is in accordance with an interaction behavior pattern associated with the first user; or
determining whether the first data interaction is in accordance with one or more relationships between nodes of a knowledge graph that represents the previous data interactions performed in relation to the first user;
determine, based on the verifying, that the data breach is confirmed;
in response to determining that the data breach is confirmed, determine one or more remediation methods that are to be used to avoid theft of data as a result of the data breach; and
implement the one or more remediation methods to avoid theft of data as a result the data breach.

2. The system of claim 1, wherein the processor is configured to verify the data breach by:
obtaining the interaction behavior pattern associated with the first user, wherein the interaction behavior pattern comprises a first set of interaction parameters associated with a plurality of previous data interactions performed in relation to the first user;
extracting, from a first interaction log of the first data interaction, a second set of interaction parameters associated with the first data interaction;
comparing the second set of interaction parameters with the first set of interaction parameters;
in response to determining that at least a threshold number of interaction parameters from the second set match with corresponding interaction parameters from the first set, determining that the data breach is not confirmed; and
in response to determining that at least a threshold number of interaction parameters from the second set do not match with corresponding interaction parameters from the first set, determining that the data breach is confirmed.

3. The system of claim 1, wherein the processor is configured to verify the data breach by:
obtaining the knowledge graph that represents the previous data interactions performed in relation to the first user, wherein the knowledge graph represents the previous data interactions performed in relation to the first user as a plurality of nodes and relationships between the nodes;
determining whether the first data interaction matches with the nodes and corresponding relationships from the knowledge graph that are associated with one or more same or similar previous data interactions;
in response to determining that the first data interaction matches with at least a threshold number of the nodes and the corresponding relationships from the knowledge graph, determining that the data breach is not confirmed; and
in response to determining that the first data interaction does not match with at least the threshold number of the nodes and the corresponding relationships from the knowledge graph, determining that the data breach is confirmed.

4. The system of claim 1, wherein the processor is further configured to:
verify the data breach using an artificial Intelligence (AI) model, wherein the AI model is trained using the interaction behavior pattern and the knowledge graph;
wherein the verifying comprises:
inputting to the AI model a first interaction log associated with the first data interaction; and
obtaining an indication of whether the data breach is confirmed as a result output by the AI model.

5. The system of claim 1, wherein the processor is configured to determine that the data breach has potentially occurred by:
obtaining a first interaction log associated with the first data interaction;
identifying, from the historical interaction logs, the one or more historical interaction logs that are associated with previous data interactions that are same or similar to the first data interaction;
comparing the first interaction log with the one or more historical interaction logs; and
determining that the data breach has potentially occurred in response to determining that the first interaction log at least partially does not match with the one or more historical interaction logs.

6. The system of claim 1, wherein the processor is further configured to:
monitor a plurality of communication channels configured for performing data interactions by users;
detect, based on the monitoring, that the first data interaction has been performed in relation to the first user using a first communication channel of the plurality of communication channels;
determine that the data breach associated with the first communication channel can cause a second data breach associated with a second communication channel of the plurality of communication channels;
determine one or more second remediation methods that are to be used to avoid theft of data associated with the second communication channel; and
implement the one or more second remediation methods in real time to avoid theft of data associated with the second communication channel.

7. The system of claim 6, wherein the plurality of communication channels comprise email, social media, mobile application, and web application.

8. A method comprising:
detecting that a first data interaction has been performed in relation to a first user;
determining, based on one or more historical interaction logs associated with previous data interactions performed in relation to the first user, that the first data interaction does not at least partially match with the previous data interactions performed in relation to the first user;
in response to determining that the first data interaction does not at least partially match with the previous data interactions performed in relation to the first user, determining that a data breach has potentially occurred;
verifying the data breach to confirm whether the data breach has occurred, wherein the verifying comprises one or more of:
determining whether the first data interaction is in accordance with an interaction behavior pattern associated with the first user; or
determining whether the first data interaction is in accordance with one or more relationships between nodes of a knowledge graph that represents the previous data interactions performed in relation to the first user;
determining, based on the verifying, that the data breach is confirmed;
in response to determining that the data breach is confirmed, determining one or more remediation methods that are to be used to avoid theft of data as a result of the data breach; and
implementing the one or more remediation methods to avoid theft of data as a result the data breach.

9. The method of claim 8, wherein verifying the data breach comprises:
obtaining the interaction behavior pattern associated with the first user, wherein the interaction behavior pattern comprises a first set of interaction parameters associated with a plurality of previous data interactions performed in relation to the first user;
extracting, from a first interaction log of the first data interaction, a second set of interaction parameters associated with the first data interaction;
comparing the second set of interaction parameters with the first set of interaction parameters;
in response to determining that at least a threshold number of interaction parameters from the second set match with corresponding interaction parameters from the first set, determining that the data breach is not confirmed; and
in response to determining that at least a threshold number of interaction parameters from the second set do not match with corresponding interaction parameters from the first set, determining that the data breach is confirmed.

10. The method of claim 8, wherein verifying the data breach comprises:
obtaining the knowledge graph that represents the previous data interactions performed in relation to the first user, wherein the knowledge graph represents the previous data interactions performed in relation to the first user as a plurality of nodes and relationships between the nodes;
determining whether the first data interaction matches with the nodes and corresponding relationships from the knowledge graph that are associated with one or more same or similar previous data interactions;
in response to determining that the first data interaction matches with at least a threshold number of the nodes and the corresponding relationships from the knowledge graph, determining that the data breach is not confirmed; and
in response to determining that the first data interaction does not match with at least the threshold number of the nodes and the corresponding relationships from the knowledge graph, determining that the data breach is confirmed.

11. The method of claim 8, further comprising:
verifying the data breach using an artificial Intelligence (AI) model, wherein the AI model is trained using the interaction behavior pattern and the knowledge graph;
wherein the verifying comprises:
inputting to the AI model a first interaction log associated with the first data interaction; and
obtaining an indication of whether the data breach is confirmed as a result output by the AI model.

12. The method of claim 8, wherein determining that the data breach has potentially occurred comprises:
obtaining a first interaction log associated with the first data interaction;
identifying, from the historical interaction logs, the one or more historical interaction logs that are associated with previous data interactions that are same or similar to the first data interaction;
comparing the first interaction log with the one or more historical interaction logs; and
determining that the data breach has potentially occurred in response to determining that the first interaction log at least partially does not match with the one or more historical interaction logs.

13. The method of claim 8, further comprising:
monitoring a plurality of communication channels configured for performing data interactions by users;
detecting, based on the monitoring, that the first data interaction has been performed in relation to the first user using a first communication channel of the plurality of communication channels;
determining that the data breach associated with the first communication channel can cause a second data breach associated with a second communication channel of the plurality of communication channels;
determining one or more second remediation methods that are to be used to avoid theft of data associated with the second communication channel; and
implementing the one or more second remediation methods in real time to avoid theft of data associated with the second communication channel.

14. The method of claim 13, wherein the plurality of communication channels comprise email, social media, mobile application, and web application.

15. A non-transitory computer-readable medium storing instructions that when executed by a processor causes the processor to:
detect that a first data interaction has been performed in relation to a first user;
determine, based on one or more historical interaction logs associated with previous data interactions performed in relation to the first user, that the first data interaction does not at least partially match with the previous data interactions performed in relation to the first user;
in response to determining that the first data interaction does not at least partially match with the previous data interactions performed in relation to the first user, determine that a data breach has potentially occurred;
verify the data breach to confirm whether the data breach has occurred, wherein the verifying comprises one or more of:
determining whether the first data interaction is in accordance with an interaction behavior pattern associated with the first user; or
determining whether the first data interaction is in accordance with one or more relationships between nodes of a knowledge graph that represents the previous data interactions performed in relation to the first user;
determine, based on the verifying, that the data breach is confirmed;
in response to determining that the data breach is confirmed, determine one or more remediation methods that are to be used to avoid theft of data as a result of the data breach; and
implement the one or more remediation methods to avoid theft of data as a result the data breach.

16. The non-transitory computer-readable medium of claim 15, wherein verifying the data breach comprises:
obtaining the interaction behavior pattern associated with the first user, wherein the interaction behavior pattern comprises a first set of interaction parameters associated with a plurality of previous data interactions performed in relation to the first user;
extracting, from a first interaction log of the first data interaction, a second set of interaction parameters associated with the first data interaction;
comparing the second set of interaction parameters with the first set of interaction parameters;
in response to determining that at least a threshold number of interaction parameters from the second set match with corresponding interaction parameters from the first set, determining that the data breach is not confirmed; and
in response to determining that at least a threshold number of interaction parameters from the second set do not match with corresponding interaction parameters from the first set, determining that the data breach is confirmed.

17. The non-transitory computer-readable medium of claim 15, wherein verifying the data breach comprises:
obtaining the knowledge graph that represents the previous data interactions performed in relation to the first user, wherein the knowledge graph represents the previous data interactions performed in relation to the first user as a plurality of nodes and relationships between the nodes;
determining whether the first data interaction matches with the nodes and corresponding relationships from the knowledge graph that are associated with one or more same or similar previous data interactions;
in response to determining that the first data interaction matches with at least a threshold number of the nodes and the corresponding relationships from the knowledge graph, determining that the data breach is not confirmed; and
in response to determining that the first data interaction does not match with at least the threshold number of the nodes and the corresponding relationships from the knowledge graph, determining that the data breach is confirmed.

18. The non-transitory computer-readable medium of claim 15, wherein the instructions further cause the processor to:
verify the data breach using an artificial Intelligence (AI) model, wherein the AI model is trained using the interaction behavior pattern and the knowledge graph;
wherein the verifying comprises:
inputting to the AI model a first interaction log associated with the first data interaction; and
obtaining an indication of whether the data breach is confirmed as a result output by the AI model.

19. The non-transitory computer-readable medium of claim 15, wherein determining that the data breach has potentially occurred comprises:
obtaining a first interaction log associated with the first data interaction;
identifying, from the historical interaction logs, the one or more historical interaction logs that are associated with previous data interactions that are same or similar to the first data interaction;
comparing the first interaction log with the one or more historical interaction logs; and
determining that the data breach has potentially occurred in response to determining that the first interaction log at least partially does not match with the one or more historical interaction logs.

20. The non-transitory computer-readable medium of claim 15, wherein the instructions further cause the processor to:
monitor a plurality of communication channels configured for performing data interactions by users;
detect, based on the monitoring, that the first data interaction has been performed in relation to the first user using a first communication channel of the plurality of communication channels;
determine that the data breach associated with the first communication channel can cause a second data breach associated with a second communication channel of the plurality of communication channels; and
determine one or more second remediation methods that are to be used to avoid theft of data associated with the second communication channel; and
implement the one or more second remediation methods in real time to avoid theft of data associated with the second communication channel.
